(19) United States
(12) Patent Application Publication
(10) Pub. No.: US 2015/0353408 A1
(43) Pub. Date: Dec. 10, 2015

(54) SHEET GLASS FORMING METHOD AND SHEET GLASS FORMING DEVICE

(71) Applicant: NIPPON ELECTRIC GLASS CO., LTD., Otsu-shi, Shiga (JP)

(72) Inventor: Yasuhiro NISHIMURA, Shiga (JP)

(21) Appl. No.: 14/762,972

(22) PCT Filed: Apr. 1, 2014
(86) PCT No.: PCT/JP2014/059609

§ 371 Date: Jul. 23, 2015

(30) Foreign Application Priority Data
Apr. 1, 2013 (JP) 2013-075971

(51) Int. Cl. C03B 17/06

(52) U.S. Cl. CPC C03B 17/064

(57) ABSTRACT

Provided is a glass sheet forming method, including: causing molten glass (MG), which overflows to both sides from a supply channel (2) formed along a top of a forming trough (1), to flow downward along wedge-shaped inclined surface portions (3b) of the forming trough (1) while expansion in a width direction of the molten glass (MG) is restricted with a pair of guides (4); and fusing streams of the molten glass (MG) integrally to each other at a lower end portion (5) of the forming trough (1), to thereby form a glass sheet. A value of a ratio (H/T) is set to fall within a range of from 0.8 to 1.5, where H represents a projection dimension of each of the pair of guides (4) with respect to each of the wedge-shaped inclined surface portions (3b) and T represents a thickness of the molten glass (MG) to flow downward between the pair of guides (4).

### TECHNICAL FIELD

The present invention relates to a glass sheet forming method and a glass sheet forming apparatus using an overflow downdraw method.

### BACKGROUND ART

As is well known, glass sheet products as typified by a glass substrate for a flat panel display (FPD) such as a liquid crystal display, a plasma display, or an organic light-emitting diode (OLED) display are required to satisfy rigorous quality requirements for surface defects and waviness. Therefore, as a manufacturing method for glass sheet products of this type, an overflow downdraw method capable of obtaining a smooth glass surface with fewer defects may be employed in many cases.

Patent Literature 1 discloses an example of the overflow downdraw method. In the embodiment disclosed in Patent Literature 1, molten glass that overflows to both sides from a supply channel formed along a top of a forming trough is caused to flow downward along wedge-shaped inclined surface portions of the forming trough while expansion in the width direction of the molten glass is restricted with a pair of guides, and streams of the molten glass are fused integrally to each other at a lower end portion of the forming trough, to thereby form a glass sheet.

### CITATION LIST

Patent Literature 1: JP 2012-214349 A

### SUMMARY OF INVENTION

### Technical Problems

Incidentally, when the glass sheet is formed by the overflow downdraw method, the flows of the molten glass to flow downward along the inclined surface portions of the forming trough are liable to be disturbed. Specifically, in the molten glass during downward flow, a flow away from the guides toward a central side in the width direction is generated near the guides due to influences of gravity and surface tension of the molten glass.

With this, at both ends in the width direction of the molten glass, a part that is locally thinner or thicker than a central portion is formed. When such a phenomenon occurs, there is a problem in that a thickness of a glass sheet to be formed of the molten glass is non-uniform in the width direction, thereby reducing smoothness of the glass surface. This problem may induce glass breakage such as cracking at the time, for example, when the glass sheet (glass ribbon) formed as described above is cut out into glass sheets having a product size.

In view of the circumstances described above, it is a technical object of the present invention to suppress, in a case of forming a glass sheet by an overflow downdraw method, non-uniformity in thickness in a width direction of molten glass to flow downward along inclined surface portions of a forming trough, thereby enhancing smoothness of a surface of the glass sheet to be formed of the molten glass.

### Solution to Problems

According to one embodiment of the present invention, which is devised for achieving the above-mentioned object, there is provided a glass sheet forming method, comprising: causing molten glass, which overflows to both sides from a supply channel formed along a top of a forming trough, to flow downward along wedge-shaped inclined surface portions of the forming trough while expansion in a width direction of the molten glass is restricted with a pair of guides; and fusing streams of the molten glass integrally to each other at a lower end portion of the forming trough, to thereby form a glass sheet, wherein a value of a ratio H/T is set to fall within a range of from 0.8 to 1.5, where H represents a projection dimension of each of the pair of guides with respect to each of the wedge-shaped inclined surface portions and T represents a thickness of the molten glass to flow downward between the pair of guides.

As a result of extensive studies, the inventor of the present invention has found that, on each of the wedge-shaped inclined surface portions, an amount of the molten glass whose both ends in the width direction near the pair of guides are separated from the pair of guides toward a central side in the width direction varies in accordance with variation of the value of the ratio H/T, where H represents the projection dimension of each of the pair of guides with respect to each of the wedge-shaped inclined surface portions and T represents the thickness of the molten glass to flow downward between the pair of guides. Further, the inventor of the present invention has also found that, when the value of H/T is set to fall within the range of from 0.8 to 1.5, generation of the flow away from the pair of guides toward the central side in the width direction (hereinafter referred to as centered flow) can be suppressed as much as possible. Those findings demonstrate that, by such a method, at both the ends in the width direction of the molten glass, formation of apart that is locally thinner or thicker than the central portion can be prevented. As a result, the thickness of the molten glass during downward flow can be suppressed from being non-uniform in the width direction, thereby being capable of enhancing smoothness of a surface of a glass sheet to be formed of the molten glass. Note that, the reason why the advantages as described above can be obtained is assumed as follows. Specifically, when T is excessively smaller than H, due to surface tension, the pair of guides exerts an excessively great force of pulling both the ends of the molten glass. Thus, a force of hindering the centered flow is also excessively great, and hence a thickness at each of the ends is larger than that at the central portion. Meanwhile, when T is excessively larger than H, due to the surface tension, the pair of guides does not exert a sufficient force of pulling both the ends of the molten glass. Thus, the force of hindering the centered flow is not sufficient, and hence the thickness at each of the ends is smaller than that at the central portion. However, it is assumed that, when the value of H/T is set to fall within the range of from 0.8 to 1.5, the force of hindering the centered flow is optimized.

In the above-mentioned method, it is preferred that the value of the ratio H/T be set to fall within a range of from 1.1 to 1.3.

With this, generation of the centered flow can be more effectively suppressed. Further, a value of the projection dimension H of each of the pair of guides with respect to each of the wedge-shaped inclined surface portions is larger than a value of the thickness T of the molten glass to flow downward between the pair of guides. Thus, a risk that the molten glass during downward flow flows over the pair of guides due to the influence of the gravity and is deviated from each of the wedge-shaped inclined surface portions of the forming trough can be reduced as much as possible.

In the above-mentioned method, it is preferred that the projection dimension H be gradually increased along a direction in which the molten glass flows downward along the each of the wedge-shaped inclined surface portions.

The molten glass to flow downward along each of the wedge-shaped inclined surface portions gradually decreases in temperature along with the downward flow, that is, the molten glass gradually increases in viscosity along with the downward flow. In accordance therewith, the thickness T of the molten glass also gradually increases along with the downward flow. Thus, when the projection dimension H is gradually increased along a direction in which the molten glass flows downward along each of the wedge-shaped inclined surface portions, there is an advantage in optimizing the force of hindering the centered flow. Further, this advantage leads also to an optimization of a degree of the projection dimension H. Thus, for example, at the time of forming the pair of guides, which are made of materials containing platinum group elements such as platinum and rhodium, unnecessary extra materials need not be used. In this way, another advantage can be obtained in reducing material cost.

Further, according to one embodiment of the present invention, which is devised for achieving the above-mentioned object, there is provided a glass sheet forming apparatus, comprising a forming trough for causing molten glass, which overflows to both sides from a supply channel formed along a top of the forming trough, to flow downward along wedge-shaped inclined surface portions of the forming trough while expansion in a width direction of the molten glass is restricted with a pair of guides, and fusing streams of the molten glass integrally to each other at a lower end portion of the forming trough, to thereby form a glass sheet, wherein a value of H is set so that a value of a ratio H/T ranges from 0.8 to 1.5, where H represents a projection dimension of each of the pair of guides with respect to each of the wedge-shaped inclined surface portions and T represents a thickness of the molten glass to flow downward between the pair of guides.

With this configuration, when the thickness T of the molten glass to flow downward between the pair of guides is determined as a design thickness, and then a value of the projection dimension H of each of the pair of guides with respect to each of the wedge-shaped inclined surface portions is set (designed) so that the value of H/T ranges from 0.8 to 1.5, the same functions and advantages as those of the matters in the above description of the glass sheet forming method can be obtained.

In the above-mentioned structure, it is preferred that the value of H be set so that the value of the ratio H/T ranges from 1.1 to 1.3.

With this, the same functions and advantages as those of the matters in the above description of the glass sheet forming method can be obtained.

In the above-mentioned structure, it is preferred that the projection dimension H be gradually increased along a direction in which the molten glass flows downward along the each of the wedge-shaped inclined surface portions.

With this, the same functions and advantages as those of the matters in the above description of the glass sheet forming method can be obtained.

### Advantageous Effects of Invention

As described above, according to the one embodiment of the present invention, it is possible to suppress, in the case of forming a glass sheet by the overflow downdraw method, the non-uniformity in thickness in the width direction of the molten glass to flow downward along the inclined surface portions of the forming trough, thereby enhancing the smoothness of the surface of the glass sheet to be formed of the molten glass.

### BRIEF DESCRIPTION OF DRAWINGS

FIG. 1 is a side view of a glass sheet forming apparatus according to a first embodiment of the present invention.

FIG. 2 is a vertical sectional front view of the glass sheet forming apparatus according to the first embodiment of the present invention.

FIG. 3a is a view illustrating functions and advantages of a glass sheet forming method according to the first embodiment of the present invention.

FIG. 3b is a view illustrating the functions and advantages of the glass sheet forming method according to the first embodiment of the present invention.

FIG. 3c is a view illustrating the functions and advantages of the glass sheet forming method according to the first embodiment of the present invention.

FIG. 4 is a graph showing a relationship between a distance from a guide and a thickness of molten glass.

FIG. 5 is a graph showing a relationship between a standard deviation σ of the thickness of the molten glass and a ratio H/T between a projection dimension H of the guide with respect to an inclined surface portion and a thickness T of the molten glass that flows downward between a pair of the guides.

FIG. 6 is a vertical sectional front view of a glass sheet forming apparatus according to a second embodiment of the present invention.

FIG. 7 is a graph showing a relationship between a temperature, a viscosity, and the thickness T of the molten glass.

FIG. 8 is a graph showing a relationship between the thickness T of the molten glass and the projection dimension H of the guide with respect to the inclined surface portion.

### DESCRIPTION OF EMBODIMENTS

Now, a glass sheet forming apparatus according to embodiments of the present invention is described with reference to the accompanying drawings.

### First Embodiment

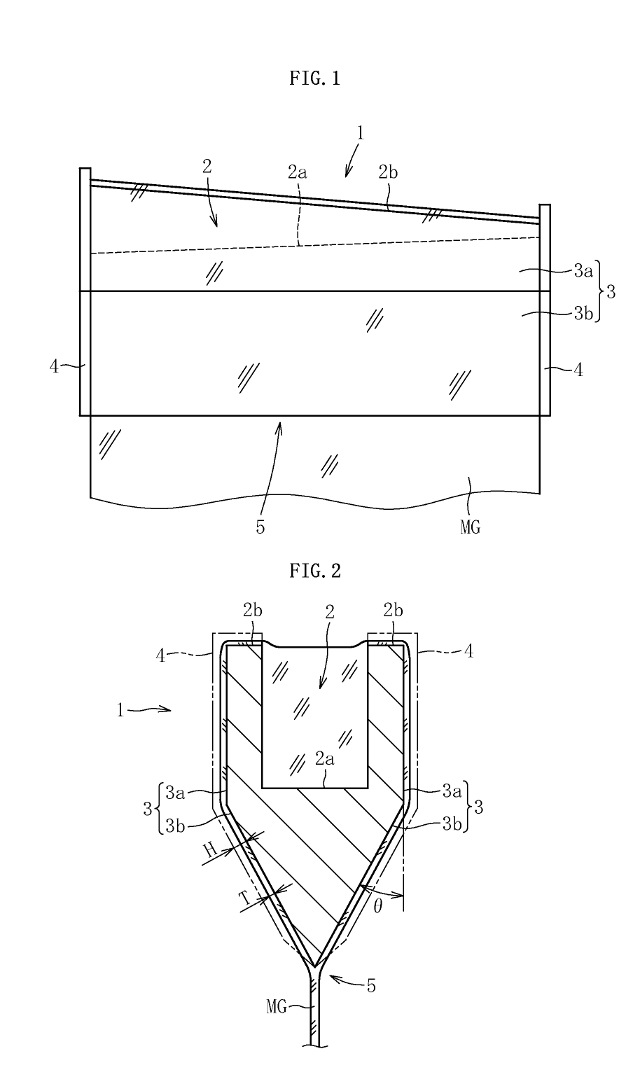

FIG. 1 is a side view of a glass sheet forming apparatus according to a first embodiment of the present invention, and FIG. 2 is a vertical sectional front view of the glass sheet forming apparatus. As illustrated in those figures, the glass sheet forming apparatus comprises, as a main component, a forming trough 1 for executing an overflow downdraw method.

The forming trough 1 is elongated in a width direction of a glass sheet to be manufactured (right-and-left direction in FIG. 1), and a supply channel 2 for pouring molten glass MG is formed along a top of the forming trough 1. Further, streams of the molten glass MG overflowing from the supply channel 2 to both sides are caused to flow downward along outer surface portions 3 of the forming trough 1 while expansion in the width direction thereof is restricted with a pair of guides 4, and are fused integrally to each other at a lower end portion 5 of the forming trough 1. Note that, after the integral fusion, the molten glass MG is fed downward with its front surface side and rear surface side being nipped between pulling rollers and the like (not shown).

The supply channel 2 is formed so that a bottom portion 2a thereof has a rising gradient from the proximal side to an inlet (left side in FIG. 1) of the molten glass MG toward the distal side from the inlet (right side in FIG. 1) of the molten glass MG. Further, overflowing portions 2b formed along upper ends of side walls of the supply channel 2, from which the molten glass MG overflows, are each formed to have a falling gradient from the proximal side to the inlet toward the distal side from the inlet. With this, the molten glass MG that has flown in the supply channel 2 gradually decreases in depth from the proximal side to the inlet toward the distal side from the inlet.

The outer surface portions 3 are formed continuously with the overflowing portions 2b on both sides of the supply channel 2, and the pair of outer surface portions 3 each comprise a perpendicular surface portion 3a perpendicular to a horizontal plane, and an inclined surface portion 3b continuous with a lower part of the perpendicular surface portion 3a. The pair of inclined surface portions 3b are inclined at an angle θ respectively with respect to the perpendicular surface portions 3a, come closer to each other toward a lower side, and merge with each other at the lower end portion 5 of the forming trough 1. With this, the pair of inclined surface portions 3a exhibits a wedge shape. Note that, it is preferred that a value of θ range from 1 [°] to 10 [°].

Flat plate members are fixed respectively to both ends in a longitudinal direction of the forming trough 1, and outer edge portions thereof project outward from the outer surface portions 3 to opposite sides. Those projecting portions serve as the guides 4 so that the molten glass MG extends along a downward flow path (direction), and that the expansion toward the width direction of the molten glass MG is restricted. Note that, as a material for the guides 4 (flat plate members), there may be employed materials containing platinum group elements such as platinum and rhodium. Further, a projection dimension H of each of the guides 4 with respect to the inclined surface portion 3b is set (designed) in accordance with a thickness T of the molten glass MG to flow downward between the pair of guides 4. Specifically, the projection dimension H is set (designed) so that a value of a ratio H/T therebetween ranges from 0.8 to 1.5, more preferably, from 1.1 to 1.3. In addition, in each of the guides 4 that project from the pair of outer surface portions 3, the projection dimension H with respect to the inclined surface portion 3b decreases downward near the lower end portion 5 of the forming trough 1, and reaches zero at the lower end portion 5 of the forming trough 1. Note that, the projection dimensions H of the pair of guides 4 with respect to the inclined surface portions 3b are equal to each other. Further, another projection dimension of each of the guides 4 with respect to the perpendicular surface portion 3a is equal to the above-mentioned value of H.

In this case, a value of the thickness T [m] of the molten glass is predetermined as a design thickness by substituting parameters of the molten glass MG and the above-mentioned angle θ, for example, into the equation of [Math 1] assuming that the parameters include an average viscosity μ [Pa·s], a flow rate V [m/s], a density ρ [kg/m³], and a gravitational acceleration g [m/s²]. Then, based on this determined design thickness, the projection dimension H of the guide 4 with respect to the inclined surface portion 3b is set (designed). Note that, the value of T calculated from the equation of [Math 1] represents an average thickness of the molten glass MG to flow downward between the pair of guides 4, which is substantially equal to the thickness of the molten glass MG in a part except both the ends in the width direction.

$$T = \sqrt[3]{\frac{3 μ V}{ρ g cos θ}} \qquad [ Math 1 ]$$

Note that, the value of the ratio H/T may be set by predetermining, as described above, the thickness T (design thickness) of the molten glass MG to flow downward along the inclined surface portion 3b, and by setting (designing), based on the value of T, the projection dimension H of the guide 4 with respect to the inclined surface portion 3b, or may be set by adjusting the thickness T through control of the parameters in the equation of [Math 1] depending on the predetermined projection dimension H of the guide 4 with respect to the inclined surface portion 3b.

In the following, with reference to the accompanying drawings, description is made of functions and advantages of a glass sheet forming method according to the first embodiment of the present invention, which is performed by using the glass sheet forming apparatus described above.

On the inclined surface portion 3b, in the molten glass MG to flow downward between the pair of guides 4, a flow away from the guides 4 toward a central side in the width direction (hereinafter referred to as centered flow) is generated near the guides 4 due to influences of gravity and surface tension of the molten glass MG. As a result of extensive studies, the inventor of the present invention has found that the amount of the centered flow that is separated from the guides 4 toward the central side in the width direction varies in accordance with variation of the value of the ratio H/T between the projection dimension H of each of the guides 4 with respect to the inclined surface portion 3b and the thickness T of the molten glass MG to flow downward between the pair of guides 4.

Further, the inventor of the present invention has also found that, when the value of the ratio H/T is set to fall within a range of from 0.8 to 1.5, more preferably, from 1.1 to 1.3, generation of the centered flow can be suppressed as much as possible. With this, at both the ends in the width direction of the molten glass MG, formation of a part that is locally thinner or thicker than a central portion can be prevented. As a result, the thickness of the molten glass MG during downward flow can be suppressed from being non-uniform in the width direction, thereby being capable of enhancing smoothness of a surface of a glass sheet to be formed of the molten glass MG.

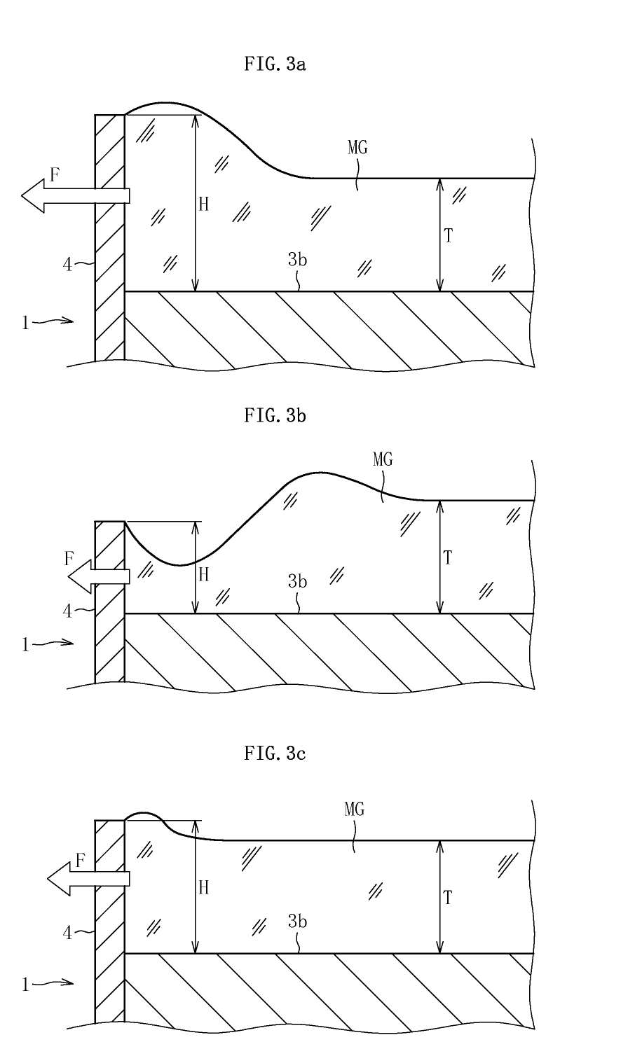

In this context, the reason why the functions and advantages as described above can be obtained is assumed as follows. Note that, FIGS. 3a to 3c that are referred to in the description of the reason are each a sectional view orthogonal to the inclined surface portion 3b.

As illustrated in FIG. 3a, when T is excessively smaller than H (H/T>1.5), due to surface tension, the guides 4 exert an excessively great force of pulling both the ends of the molten glass MG. Thus, a force F of hindering the centered flow is also excessively great, and hence a thickness at each of the ends is larger than that at the central portion (part having a thickness substantially equal to the average thickness of the molten glass MG).

Meanwhile, as illustrated in FIG. 3b, when T is excessively larger than H (H/T<0.8), due to surface tension, the guides 4 do not exert a sufficient force of pulling both the ends of the molten glass MG. Thus, the force F of hindering the centered flow is not sufficient, and hence the thickness at each of the ends is smaller than that at the central portion.

However, as illustrated in FIG. 3c, it is assumed that, when the value of the ratio H/T ranges from 0.8 to 1.5, more preferably, from 1.1 to 1.3, the force F of hindering the centered flow is optimized. Note that, when the value of the H/T ranges from 1.1 to 1.3, a value of the projection dimension H of the guide with respect to the inclined surface portion 3b is larger than the value of the thickness T of the molten glass MG to flow downward between the pair of guides. Thus, a risk that the molten glass MG during downward flow flows over the guides 4 due to the influence of the gravity and is deviated from the inclined surface portions 3b of the forming trough 1 can be reduced as much as possible.

### Second Embodiment

In the following, description is made of a glass sheet forming apparatus according to a second embodiment of the present invention. Note that, in the description of the glass sheet forming apparatus according to the second embodiment and in the drawings referred to therein, components having the same functions or shapes as those of the components in the above description of the glass sheet forming apparatus according to the first embodiment are denoted by the same reference symbols to omit redundant description. Description is made only of differences from the first embodiment.

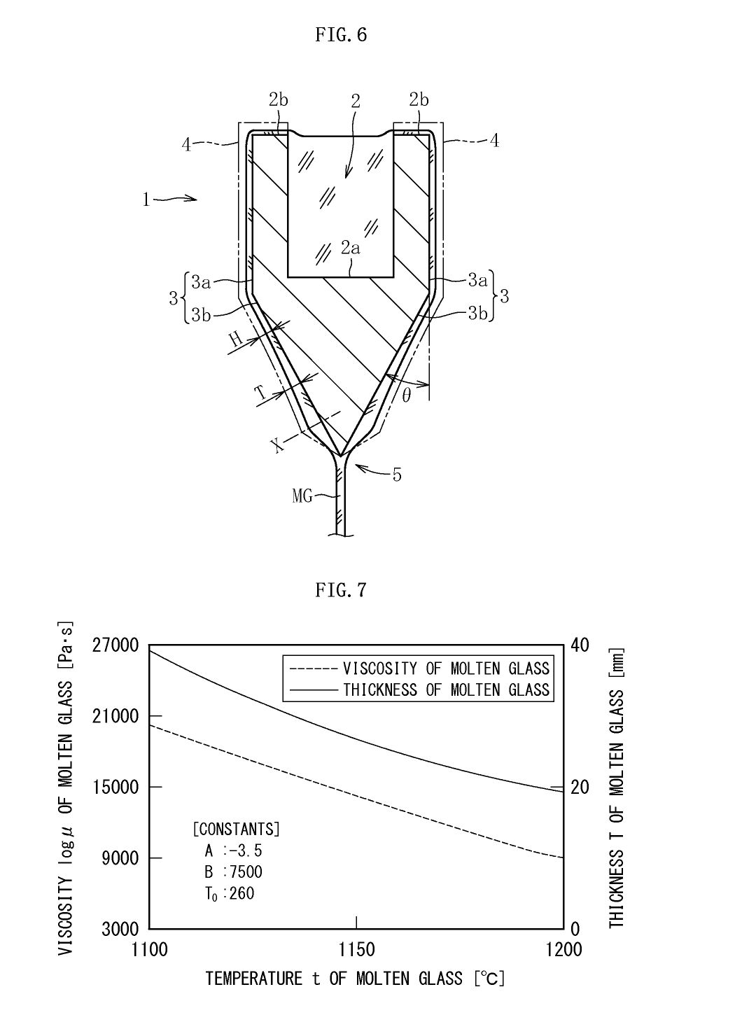

FIG. 6 is a vertical sectional front view of the glass sheet forming apparatus according to the second embodiment of the present invention. This glass sheet forming apparatus according to the second embodiment is different from the glass sheet forming apparatus according to the first embodiment described above in that the projection dimension H of the guide 4 with respect to the inclined surface portion 3b is set (designed) in consideration of variation in viscosity of the molten glass MG to flow downward along the inclined surface portion 3b. Specifically, the characteristic that the molten glass MG to flow downward along the inclined surface portion 3b gradually decreases in temperature along with the downward flow, that is, gradually increases in viscosity along with the downward flow is taken into consideration.

In the glass sheet forming apparatus according to the first embodiment described above, the thickness T (average thickness) of the molten glass MG is determined as a design thickness only based on the equation of [Math 1]. Meanwhile, in the glass sheet forming apparatus according to the second embodiment, the thickness T of the molten glass MG is determined as the design thickness not only based on the equation of [Math 1] but also based on the following equation of [Math 2] (Vogel-Fulcher-tamman equation), where μ [Pa·s] is the viscosity of the molten glass MG, t [K] is an absolute temperature, and A, B, and t₀ are three constants to be determined based on a composition of the molten glass MG. In other words, the value of the thickness T of the molten glass varies (gradually increases) at positions on the inclined surface portion 3b along the direction in which the molten glass MG flows downward. In addition, the projection dimension H is set (designed) so that the value of the ratio H/T ranges from 0.8 to 1.5, more preferably, from 1.1 to 1.3. In this way, the projection dimension H gradually increases along the direction in which the molten glass MG flows downward along the inclined surface portion 3b.

$$log μ = A + \frac{B}{t - {t}_{0}} \qquad [ Math 2 ]$$

Note that, also in the glass sheet forming apparatus according to the second embodiment, the value of the ratio H/T may be set (designed) by predetermining, as described above, the thickness T (design thickness) of the molten glass MG to flow downward along the inclined surface portion 3b, and by setting (designing), based on the value of T, the projection dimension H of the guide 4 with respect to the inclined surface portion 3b, or may be set by adjusting the thickness T through control of the parameters in the equations of [Math 1] and [Math 2] depending on the predetermined projection dimension H of the guide 4 with respect to the inclined surface portion 3b.

In this context, description is made of a specific example of a procedure for setting (designing) the projection dimension H. In this example, the molten glass MG contains, in terms of mass %, SiO₂: 50% to 80%, Al₂O₃: 5% to 25%, B₂O₃: 0% to 15%, Na₂O: 1% to 20%, and K₂O: 0% to 10%. Further, the above-mentioned constants A, B, and t₀ are determined, for example, as A=−3.5, B=7,500, and t₀=260. In addition, as shown in FIG. 7, it is assumed that, when the flow rate V of the molten glass is 0.4 [m³/h], the density ρ thereof is 2,500 [kg/m³], and the angle θ is 20 [°], a temperature of the molten glass MG at the overflowing portions 2b of the supply channel 2 is 1,200 [° C.], a temperature of the molten glass MG at the lower end portion 5 is 1,100 [° C.], the viscosity μ of the molten glass MG increases from 3, 000 [Pa·s] to 28,000 [Pa·s] along with the downward flow from the overflowing portions 2b to the lower end portion 5, and the thickness T of the molten glass MG increases from approximately 20 mm to approximately 40 mm.

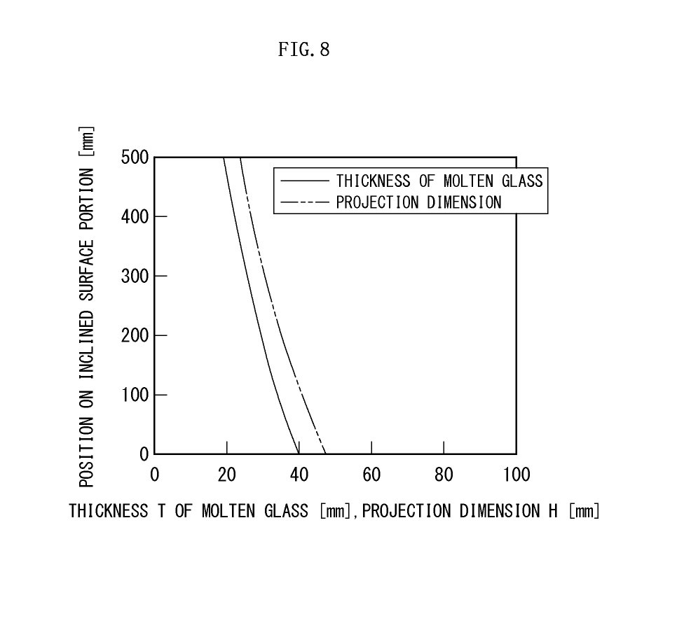

When the value of H/T is set to 1.2, the projection dimension H of the guide 4 with respect to the inclined surface portion 3b, which is calculated based on the equations of [Math 1] and [Math 2], varies as shown in FIG. 8. Note that, the “POSITION ON INCLINED SURFACE PORTION” of the ordinate axis in FIG. 8 represents a position that is away upward along the inclined surface portion 3b from the position X indicated in FIG. 6 (position at which the projection dimension H is largest) as the origin by a numerical value placed on the ordinate axis with respect to the origin).

In the following, description is made of functions and advantages of a glass sheet forming method according to the second embodiment of the present invention, which is performed by using the glass sheet forming apparatus described above.

Also by the glass sheet forming method according to the second embodiment, the same functions and advantages as those of the glass sheet forming method according to the first embodiment described above can be obtained. Further, as the thickness T of the molten glass MG gradually increases along with the downward flow, the projection dimension H gradually increases. Thus, there is an advantage in optimizing the force F of hindering the centered flow. Further, this advantage leads also to an optimization of a degree of the projection dimension H. Thus, for example, at the time of forming the guides 4, which are made of the materials containing platinum group elements such as platinum and rhodium, unnecessary extra materials need not be used. In this way, another advantage can be obtained in reducing material cost.

Note that, the configuration of the glass sheet forming apparatus according to the present invention is not limited to those of the embodiments described above. Specifically, in the embodiments described hereinabove, the guides (flat plate members) and the forming trough are provided as separate members, but those members may be formed integrally with each other. Further, in the embodiments described hereinabove, the projection dimension of the guide with respect to the inclined surface portion and the projection dimension of the guide with respect to the perpendicular surface portion are equal to each other, but those dimensions may be unequal to each other. Note that, the degree of the projection dimension of the guide with respect to the perpendicular surface portion has substantially no influence on the functions and advantages of the present invention.

In addition, in the second embodiment described above, based on the equations of [Math 1] and [Math 2], the projection dimension gradually increases along the direction in which the molten glass flows downward along the inclined surface portion, but the present invention is not limited thereto. The projection dimension H need not necessarily be set based on those equations as long as the projection dimension H is set (designed) so that the value of the ratio H/T ranges from 0.8 to 1.5, more preferably, from 1.1 to 1.3.

### EXAMPLES

As Examples of the present invention, simulation tests to verify how a distribution of the thickness in the width direction of the molten glass varied on the inclined surface portion of the forming trough in accordance with variation of the value of the ratio H/T between the thickness T of the molten glass to flow downward between the pair of guides and the projection dimension H of each of the guides with respect to the inclined surface portion were conducted by using five guides that were different from each other in projection dimension with respect to the inclined surface portion. In the following, testing conditions for the verification are listed. Note that, in Examples, the glass sheet forming apparatus have the same configuration as that of the glass sheet forming apparatus according to the above-described embodiments of the present invention. Further, numerical values in Examples are obtained through conversion of numerical values in the simulation tests to those in a case where a forming trough of a full size is used.

First, using the equation of [Math 1] described above, the thickness T (average thickness) of the molten glass to flow downward between the pair of guides was determined. In Examples, the value of T was set to 22 [mm]. Next, using each of the five glass sheet forming apparatus that were different from each other only in projection dimension H of the guide with respect to the inclined surface portion, the molten glass was caused to flow downward along the inclined surface portion between the pair of guides. In this context, the projection dimensions H of the guide with respect to the inclined surface portion in the five glass sheet forming apparatus are listed below.
Comparative Example 1: H=17 [mm] H/T=0.77
Example 1: H=22 [mm] H/T=1.00
Example 2: H=25 [mm] H/T=1.14
Example 3: H=29 [mm] H/T=1.32
Comparative Example 2: H=34 [mm] H/T=1.55

Note that, among the forming troughs of the glass sheet forming apparatus, viscosities, flow rates, densities, and surface tensions of the molten glass to flow downward between the pair of guides are set to be respectively equal to each other, specifically, respectively set as a viscosity of 4,000 [Pa·s], a flow rate of 0.24 [m³/h], and a density of 2,500 [kg/m³]. Further, the inclination angle of the inclined surface portion with respect to the perpendicular surface portion is set to 40 [°], and a total length of the inclined surface portion is set to 500 [mm]. In addition, a distance between the pair of guides is set to 3,000 [mm].

Then, at a position 50 [mm] above the lower end portion of the forming trough along the inclined surface portion, a laser beam was radiated to the molten glass from a line laser arranged to face the molten glass during downward flow in a manner of extending in the width direction. Based on the reflected light, distributions of the thickness in the width direction of the molten glass were calculated. Further, standard deviations σ of the thickness of the molten glass were calculated in a width of 80 [mm] away from each guide and in a width of 160 [mm] away from each guide.

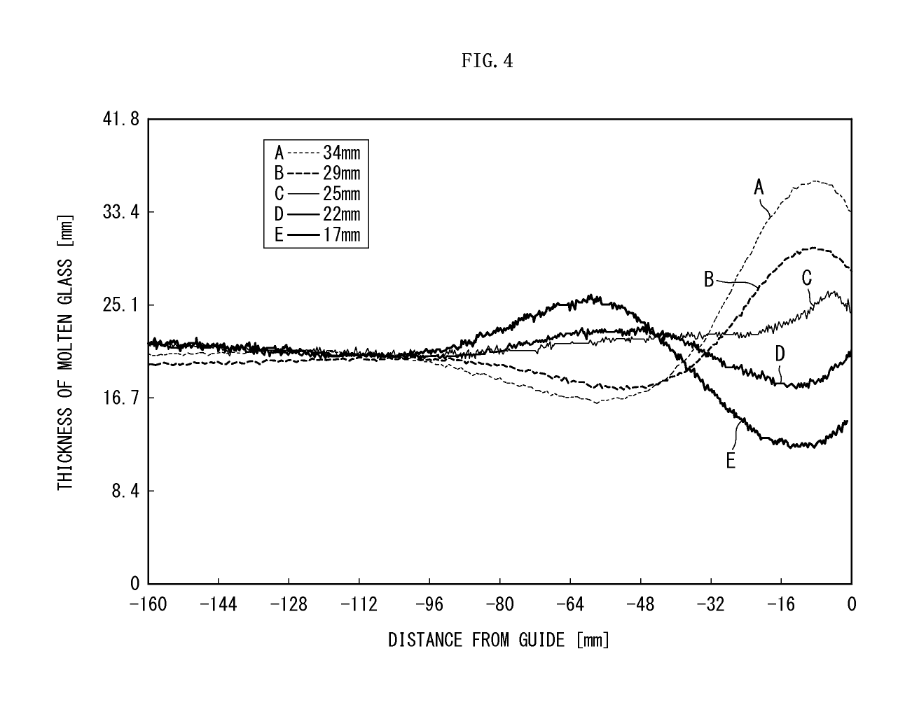

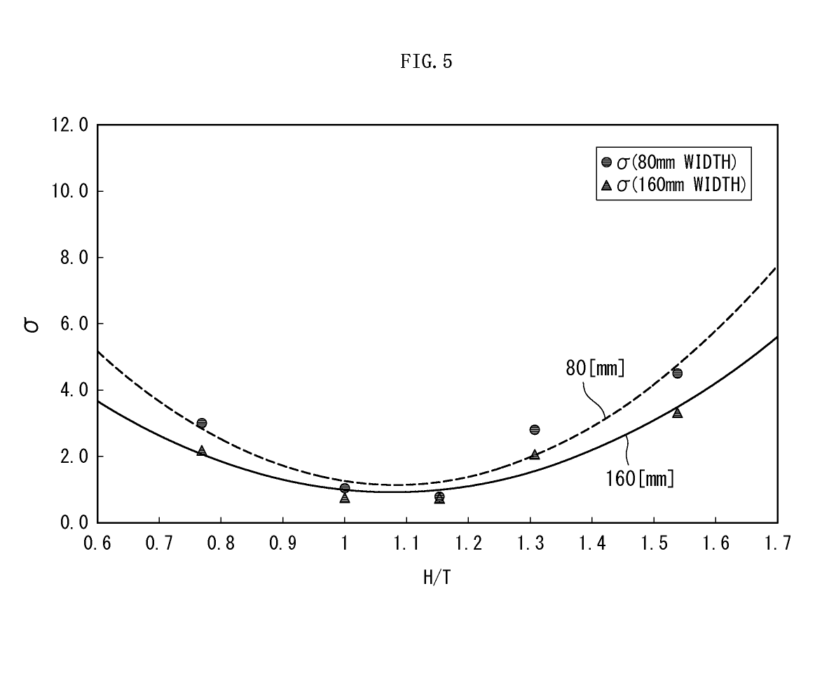

FIG. 4 shows the distributions of the thickness in the width direction of the molten glass, and FIG. 5 shows the standard deviations σ of the thickness of the molten glass in the width of 80 [mm] away from each guide and in the width of 160 [mm] away from each guide. FIG. 4 demonstrates that the spikes and the dips in the distributions of the thicknesses of the molten glass in Examples are smaller than those in Comparative Examples. In addition, FIG. 5 demonstrates that the standard deviations σ of the thickness of the molten glass in Examples, that is, fluctuations in thickness in the width direction of the molten glass in Examples are smaller than those in Comparative Examples.

From those results, it is assumed that, when the value of the ratio H/T between the projection dimension H of the guide with respect to the inclined surface portion and the thickness T of the molten glass is set to fall within the range of from 0.8 to 1.5, more preferably, from 1.1 to 1.3, non-uniformity of the thickness in the width direction of the molten glass to flow downward along the inclined surface portion is suppressed, with the result that the smoothness of a surface of a glass sheet to be formed of the molten glass can be enhanced.

### REFERENCE SIGNS LIST

1 forming trough
2 supply channel
3 outer surface portion
3a perpendicular surface portion
3b inclined surface portion
4 guide
5 lower end portion
MG molten glass
T thickness of molten glass flowing downward between pair of guides
H projection dimension of guide with respect to inclined surface portion

1. A glass sheet forming method, comprising:
causing molten glass, which overflows to both sides from a supply channel formed along a top of a forming trough, to flow downward along wedge-shaped inclined surface portions of the forming trough while expansion in a width direction of the molten glass is restricted with a pair of guides; and
fusing streams of the molten glass integrally to each other at a lower end portion of the forming trough, to thereby form a glass sheet,
wherein a value of a ratio H/T is set to fall within a range of from 0.8 to 1.5, where H represents a projection dimension of each of the pair of guides with respect to each of the wedge-shaped inclined surface portions and T represents a thickness of the molten glass to flow downward between the pair of guides.

2. The glass sheet forming method according to claim 1, wherein the value of the ratio H/T is set to fall within a range of from 1.1 to 1.3.

3. The glass sheet forming method according to claim 1, wherein the projection dimension H is gradually increased along a direction in which the molten glass flows downward along the each of the wedge-shaped inclined surface portions.

4. A glass sheet forming apparatus, comprising a forming trough for causing molten glass, which overflows to both sides from a supply channel formed along a top of the forming trough, to flow downward along wedge-shaped inclined surface portions of the forming trough while expansion in a width direction of the molten glass is restricted with a pair of guides, and fusing streams of the molten glass integrally to each other at a lower end portion of the forming trough, to thereby form a glass sheet,
wherein a value of H is set so that a value of a ratio H/T ranges from 0.8 to 1.5, where H represents a projection dimension of each of the pair of guides with respect to each of the wedge-shaped inclined surface portions and T represents a thickness of the molten glass to flow downward between the pair of guides.

5. The glass sheet forming apparatus according to claim 4, wherein the value of H is set so that the value of the ratio H/T ranges from 1.1 to 1.3.

6. The glass sheet forming apparatus according to claim 4, wherein the projection dimension H is gradually increased along a direction in which the molten glass flows downward along the each of the wedge-shaped inclined surface portions.
